(19) United States
(12) Patent Application Publication
(10) Pub. No.: US 2025/0058337 A1
(43) Pub. Date: Feb. 20, 2025

(54) Rotary Atomizer Comprising a Rotary Bowl and Magnetic Coupling Means, and Method of Assembling and/or Disassembling Such an Atomizer

(71) Applicant: Exel Industries, Epernay (FR)

(72) Inventors: Denis Vanzetto, Epernay (FR); Sylvain Perinet, Epernay (FR); Cyrille Medard, Epernay (FR)

(21) Appl. No.: 18/803,110

(22) Filed: Aug. 13, 2024

(30) Foreign Application Priority Data
Aug. 14, 2023 (FR) 2308701

(51) Int. Cl. B05B 3/10

(52) U.S. Cl. CPC B05B 3/1042; B05B 3/1014

(57) ABSTRACT

The present invention relates to a rotary atomizer for coating products comprising a main body and a bowl rotated by a rotating member about a axis of rotation defined by the main body. The bowl is equipped with first means of magnetic coupling apt to cooperate with matching second means of magnetic coupling fastened to a non-rotating part of the atomizer. The first and second means of coupling are apt to exert a force at least partially axial with respect to the axis of rotation of the bowl, the force inducing the coupling in rotation of the bowl with the rotating member. The second means of magnetic coupling are supported by an air supply skirt directly mounted on the main body.

### CROSS-REFERENCE TO RELATED APPLICATION

This application claims the benefit of FR 2308433 filed on Aug. 3, 2023, which is incorporated herein by reference in its entirety.

### BACKGROUND

The present invention relates to a rotary atomizer for coating products, comprising a main body and a bowl rotated about an axis of rotation defined by the main body. The present invention further relates to a method of assembling and/or disassembling such an atomizer.

It is known from WO2005/082542A1 to mount a bowl on a rotary atomizer by associating first and second means of magnetic coupling fastened to the bowl and to a non-rotating part of the atomizer, respectively, which makes it possible to exert an overall axial force, such as to induce a rotational coupling on the bowl and of a drive member, such as the rotor of a turbine or a shaft driven by such a rotor. Such equipment is generally satisfactory.

On the other hand, it is known to equip a rotary atomizer with an air supply skirt which serves to distribute, close to the bowl, an air flow for guiding or shaping a cloud of droplets of coating product leaving the edge of the bowl. The second means of magnetic coupling are then often disposed on a central part of a main body of the atomizer, facing a central opening of the air supply skirt wherein the bowl is engaged in order to cooperate with the means of rotation. In such case, the air supply skirt should be mounted on the main body before the bowl is set in place, which has to be precisely positioned, by hand, opposite the second means of magnetic coupling. On the other hand, during a maintenance operation, the bowl has to be separated from the main body, then the skirt has to be separated from the body, during two successive manual operations, which are difficult to carry out in an environment that is not very conducive for handling, such as a paint booth.

Furthermore, in some applications, the bowl is relatively modest in size, to the point that the grip is delicate, which induces a risk of dropping same when handled by hand. Especially when disassembly the bowl and the air supply skirt, if the operator acts on the skirt before removing the bowl, he/she has a good chance of dropping the bowl, the edge of which would probably be damaged.

With such equipment, the assembling and the disassembling of the bowl and of the air supply skirt are complex operations that are difficult to automate.

### SUMMARY

It is such drawbacks that the invention seeks more particularly to remedy by proposing a novel rotary atomizer for coating products, wherein the mounting of an air supply skirt and a bowl on a main body is facilitated, and such mounting can, to a large extent, be automated.

To this end, the subject matter of the invention relates to a rotary atomizer for coating products, comprising a main body and a bowl which is rotated by a rotating member about an axis of rotation defined by the main body, the bowl being equipped with first means of magnetic coupling apt to cooperate with second matching means of magnetic coupling fastened to a non-rotating part of the atomizer of coating products, the first and second means of coupling being apt to exert an at least partially axial force with respect to the axis of rotation of the bowl, the force inducing the coupling in rotation of the bowl with the rotating member, characterized in that the second means of magnetic coupling are supported by an air supply skirt directly mounted on the main body.

By means of the invention, the first and second means of magnetic coupling make it possible to assemble the air supply skirt and the bowl in the form of a subassembly which can be handled as a unit during the mounting on the main body, or during the disassembling thereof. The size of the subassembly is larger than the size of the bowl alone, so it is easier to grip. Same is less likely to be dropped. Furthermore, since the first and second means of coupling correctly position the bowl relative to the air supply skirt, properly mounting the skirt on the main body ensures that the bowl is properly positioned relative to the main body, hence relative to the rotating member that rotates the bowl.

According to advantageous but non-mandatory aspects of the invention, such an atomizer can incorporate one or a plurality of the following features, taken individually or according to any technically permissible combination.
The second means of magnetic coupling are mounted on, or formed by, an internal collar flange of the air supply skirt, bearing on a front face of the main body.
The first means of magnetic coupling are formed by a ferromagnetic part of the bowl and the second means of magnetic coupling are formed by at least one permanent magnet.
The first means of magnetic coupling are formed by at least one permanent magnet and the second means of magnetic coupling are formed by a ferromagnetic part of the air supply skirt.
The atomizer comprises a magnetic-pneumatic or magneto-hydraulic system which includes
   a magnetic device for hooking the air supply skirt onto the main body; and
   a pneumatic or hydraulic mechanism for locking and clamping the air supply skirt on the main body.
The magnetic hooking device is configured to exert, between the air supply skirt and the main body, an axial magnetic force, parallel to a longitudinal axis of the atomizer, with a first strength, while the pneumatic or hydraulic clamping mechanism is configured to exert between the air supply skirt and the main body an axial mechanical force, parallel to the longitudinal axis of the atomizer, with a second strength and while the second strength is strictly greater than the first strength.
The atomizer comprises seals arranged between the air supply skirt and the main body and the seals compressed by the mechanical force exerted by the pneumatic or hydraulic clamping mechanism isolate the shaping air circulation conduits from the outside of the atomizer.
The air supply skirt is provided with screwing reliefs on matching reliefs provided on the main body.
The air supply skirt is clamped to the main body by a magnetic force exerted between a part of the main body and a part of the air supply skirt.

According to a second aspect, the subject matter of the invention is a method of assembling and/or disassembling an atomizer for coating products as mentioned above, wherein
when assembling the atomizer,
   in a first assembly step, the air supply skirt and the bowl are assembled and held together by a magnetic force between the first and second means of magnetic coupling;
   in a second assembly step, a subassembly formed by the air supply skirt and the bowl is directly mounted in one operation onto the main body;
when disassembling the atomizer,
   in a first disassembly step, the subassembly formed by the air supply skirt and the bowl is separated from the main body in one operation; and
   in a second disassembly step, the air supply skirt and the bowl are separated from each other, against the magnetic force between the first and second means of magnetic coupling.

### BRIEF DESCRIPTION OF THE DRAWINGS

The invention will be clearer upon reading the following description, given only as an example, but not limited to, and making reference to the drawings wherein:

FIG. 1 is a partially exploded longitudinal section of an atomizer according to a first embodiment of the invention;

FIG. 2 is a perspective exploded longitudinal section of a magnetic-pneumatic system belonging to the atomizer shown in FIG. 1;

FIG. 3 shows, on two inserts A) and B), the atomizer shown in FIG. 1 during a first sub-step of mounting onto a main body, a subassembly comprising an air supply skirt and a bowl, insert B) being a larger scale view of detail B on insert A);

FIG. 4 is a view similar to FIG. 3, during a second sub-step of the assembly method;

FIG. 5 is a view similar to FIG. 3, during a third sub-step of the assembly method;

FIG. 6 is a view similar to FIG. 3, during a fourth sub-step of the assembly method;

FIG. 7 is a section similar to FIG. 1, for an atomizer according to a second embodiment of the invention;

FIG. 8 is a section similar to FIG. 1, for an atomizer according to a third embodiment of the invention; and

FIG. 9 is a section similar to FIG. 1, for an atomizer according to a fourth embodiment of the invention.

### DETAILED DESCRIPTION

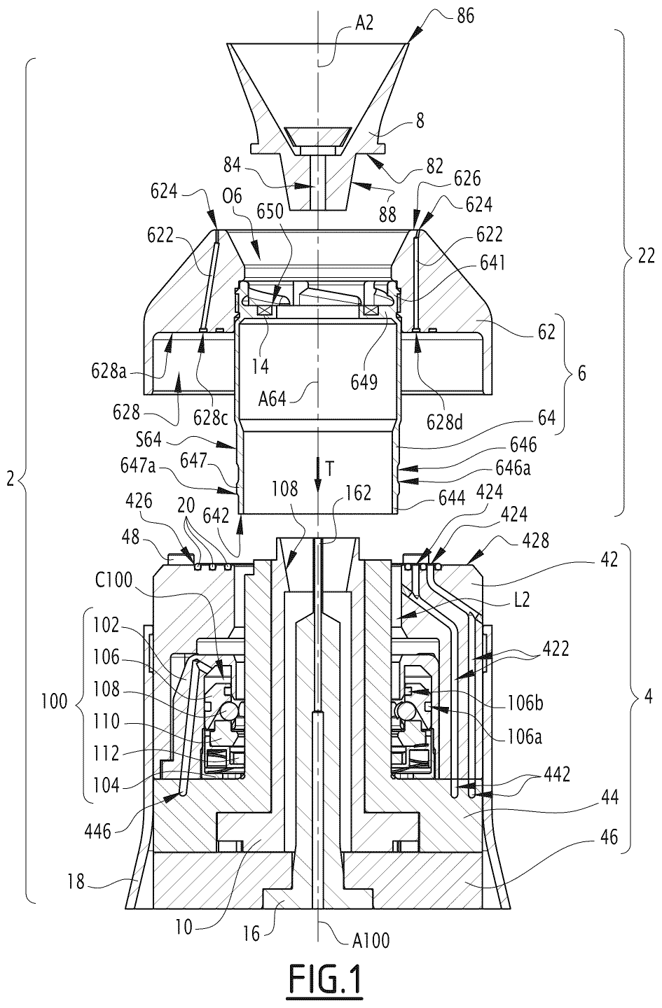

The atomizer for coating products 2 shown in FIGS. 1 to 6 comprises a main body 4 formed by the assembly of an external part 42, an internal part 44 and a base 46.

For example, the coating product is a liquid paint, a primer or a varnish intended to be applied to a bodywork or a component of a motor vehicle.

Screws 48 secure the parts 42, 44 and 46 of the main body. The screws 48 protrude out from a front face 428 of the outer part 42.

The atomizer 2 is an internal charge electrostatic atomizer and comprises a high-voltage unit (not shown) configured to bring the coating product atomized by the atomizer 2 to a given electrical potential.

A2 denotes a longitudinal axis of the atomizer 2.

A front side of the atomizer 2 or a component of the atomizer is defined as a side oriented toward a workpiece to be coated, during use of the atomizer 2, and a rear side is defined as a side oriented opposite from the front side. In the figures, the front of the atomizer 2 is oriented upwards and the rear is oriented downwards.

An air supply skirt 6 is mounted on the main body 4 in the assembled configuration of the atomizer 2. The air supply skirt 6 comprises a skirt body 62 and a sleeve 64 screwed onto the skirt body 62.

In a variant, the skirt body 62 and the sleeve are rigidly attached by crimping, welding and/or bonding.

The connection between the skirt body 62 and the sleeve 64 takes place at a front end 641 of the sleeve.

The sleeve 64 is made of a ferromagnetic material, e.g. steel.

An atomizer bowl 8 also belongs to the atomizer 2 and is intended to be rotated about the longitudinal axis A2, by a turbine of which the rotor 10 is denoted by 10. The stator of the turbine consists of the internal part 44 of the main body 4.

The bowl 8 defines a male frustoconical surface 88 converging toward the rear, while the rotor 10 defines a female frustoconical surface 108 diverging toward the front and overall matching the male frustoconical surface 88.

An annular magnet 14 is supported by an internal radial collar flange 649 of the air supply skirt 6. More precisely, the magnet 14 is arranged in a groove 650 provided in the inner radial collar flange 649 and oriented toward the front of the air supply skirt 6.

In the mounted configuration of the bowl 8 on the air supply skirt 6, and before the air supply skirt is mounted on the main body 4, an annular surface 82 of the bowl 8, which is made of a ferromagnetic material, comes opposite the permanent magnet 14, which has the effect of rigidly attaching together the parts 6 and 8 which then form a subassembly 22, unit-like and easy to manipulate when being set in place on the atomizer 2 or when being removed.

In a variant, and as shown for the third embodiment, only a part of the bowl 8 which defines the annular surface 82 is made of ferromagnetic material, e.g. in the form of a steel ring directly mounted onto the bowl 8 which is e.g. made of aluminum.

The ferromagnetic part of the bowl, which defines the surface 82, forms first means of magnetic coupling. The magnet 14 forms second means of magnetic coupling. When the air supply skirt 6 equipped with the bowl 8 is mounted and immobilized on the main body 4, the first and second means of magnetic coupling 82 and 22 cooperate in order to press the surface 88 of the bowl 8 against the surface 108 of the rotor 10, which secures the bowl and the rotor in rotation about the axis of rotation A2.

The atomizer 2 further comprises a coating product injector 16 the downstream end 162 of which penetrates into a central bore 84 of the bowl 8, in the mounted configuration of the bowl on the turbine rotor 10.

A cover 18 is mounted around the main body 4 and protects the latter against spatter of the coating product.

The skirt body 62 is equipped with a plurality of channels 622 which pass all the way therethrough, along a direction parallel to the longitudinal axis A2 in the mounted configuration of the air supply skirt 6 on the main body 4, and which each feed an outlet orifice 624 through which jets of air can be directed toward a cloud of coating product leaving an edge 86 of the bowl 8, in order to shape the jet of coating product and/or to direct same toward an object to be coated. The orifices 624 are formed on a circular front face 626 of the skirt body 62.

The skirt body 62 defines a recessed housing 628 wherein a front portion of the outer part 42 of the main body 4 is received in the mounted configuration of the air supply skirt 6 on the main body 4. The recessed housing 628 is provided on the rear of the skirt body 62.

The external part 42 of the main body 40 comprises conduits 422 for conveying air toward the air supply skirt 6. The channels 422 are supplied with air by channels 442 which extend essentially in a plane different from the plane of FIGS. 1 and 3 to 6 and of which only the downstream ends are visible in said figures.

The bottom 628a of the recessed housing 628 is equipped with two annular grooves 628c and 628d which serve as dispensers for feeding two groups of conduits 622 from the outlets 424 of the conduits 422. In order to ensure sealing against the passage of air between the conduits 422 and the grooves 628c and 628d, O-rings 20 are arranged in annular grooves 426 formed on the front face 428 of the outer part 42 of the main body 4, i.e. in an interface zone between the main body 4 and the skirt 6. The O-rings 20 are intended to bear against the bottom 628a of the recessed housing 628 and to be compressed.

In the example in the figures, the O-rings 20 and the annular grooves 426 are concentric and three in number. In a variant (not shown), the number and/or shape of O-rings 20 and annular grooves 426 are different.

The sleeve 64 is designed to be engaged in a central housing L2 of the atomizer 2 which is defined, radially to the longitudinal axis A2, between the outer part 42 and the inner part 44 of the main body 4.

642 denotes the rear edge of the sleeve 64, i.e. the edge of the sleeve opposite the skirt body 62. 644 denotes the end of the sleeve 64 which is closest to the rear edge 642. The rear edge 642 delimits the rear end 644 opposite the skirt body 62. The rear end 644 is opposite the front end 641 of the sleeve 64.

The outer radial surface of the sleeve 64 is denoted by S64. The outer radial surface is provided with a peripheral groove 646 which forms a recessed housing on the outside of the sleeve 64. 646a denotes the rear edge of the peripheral groove 646, i.e. the edge of the groove closest to the end 644 of the sleeve 64.

647 denotes an external peripheral rib of the sleeve 64 which separates the peripheral groove 646 from the end 644. 647a denotes the rear edge of the rib, i.e. the edge of the rib closest to the end 644 of the sleeve 64.

A magnetic-pneumatic system 100 is provided in the central housing L2 to ensure that the subassembly 22 is hooked onto the main body 4, as well as a clamping of the skirt 6 onto the main body. The magnetic-pneumatic system 100 comprises a magnetic hooking device 100A and a pneumatic mechanism 100B for clamping the air supply skirt 6 on the main body 4.

The hooking, obtained by means of the magnetic hooking device 100A, makes it possible to ensure that the air supply skirt 6 equipped with the bowl 8 remains in position on the main body 4, even when the latter is moved by a multi-axis robot or a reciprocator on which the atomizer is mounted. The movements of the atomizer induce accelerations on the air supply skirt 6 and on the bowl 8, which could have the effect of forcing the sleeve 64 out of the central housing L2. The magnetic hooking force is dimensioned to resist such accelerations.

The clamping force makes it possible to finalize the positioning of the air supply skirt 6 on the main body 4 and to compress the O-rings 20, thus to ensure the sealing of the outlet orifices 624 of the circuit supplying the cloud of coating product with shaping air.

The magnetic-pneumatic system 100 extends along a longitudinal axis A100 which coincides with the longitudinal axis A2 of the atomizer 2 in the mounted configuration of the magnetic-pneumatic system 100 in the atomizer 2.

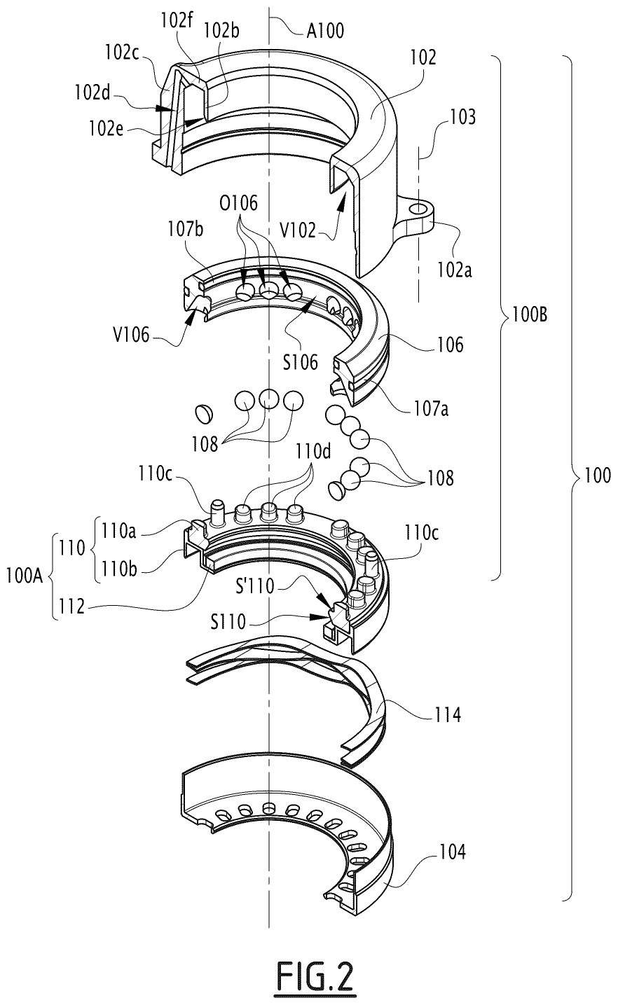

The magnetic-pneumatic system 100 comprises a cap 102 immobilized on the main body 4 by screws which extend through one or a plurality of tabs 102a provided on the outside of the cap 102. One of the screws is represented by the centerline 103 thereof in FIG. 2.

The cap 102 defines an annular volume V102 centered on the longitudinal axis A100 and which is bordered by an inner radial wall 102b and an outer radial wall 102c.

A passage 102d is provided in the thickness of the outer radial wall 102c and serves to fluidically connect a conduit 446 provided in the inner part 44 of the main body 4 and the volume V102.

On the other hand, the inner wall 102b of the cap 102 ends in a chamfered edge 102e oriented toward the volume V102 and converging toward the longitudinal axis A100 opposite the bottom 102f of the volume V102, i.e. toward the rear of the cap 102.

The magnetic-pneumatic system 100 also comprises a cup 104 placed on the rear bottom of the central housing L2. In the example of the figures, the bottom of the central housing L2 is opposite the front mouth thereof and delimited by the internal part 44.

The magnetic-pneumatic system 100 further comprises an annular piston 106 equipped with two sealing rings 107a and 107b. In the example, the sealing rings are formed by two O-rings accommodated in two peripheral grooves 106a and 106b, external and internal, respectively, formed on the piston 106. The O-rings 107a and 107b are not shown in FIG. 1, which makes it possible to see better, the grooves 106a and 106b.

In a variant, the sealing rings are formed by lip seals. According to another variant, same are mounted on the walls of the cap 102 opposite the piston 106.

The piston 106 is mobile, parallel to the axes A2 and A100 that coincide, being partially engaged in the volume V102 of the cap 102. Due to the partial engagement of the piston 106 in the housing V102 and to the bearing of the sealing segments 107a and 107b against the walls 102c and 10b, a sealed chamber of variable volume C100 is defined between the elements 102 and 106. The variable volume chamber C100 is supplied with pressurized air coming from the conduit 446 through the passage 102d. Means (not shown), such as a source of pressurized air, a proportional valve and a bleed valve, are used to supply pressurized air to the variable volume chamber C100 or to open same, depending on a sequence of assembly or disassembly of the skirt 2 on the main body 4. The pressure of the air present in the conduit 446 is controlled independently of the pressure of the air driving the rotor 10 and of the pressure of the skirt air in the conduits 442.

In a variant, part of the air driving the rotor 10 can be diverted toward the conduit 446. In such case, the variable volume chamber C100 can be supplied with pressurized air as soon as the turbine is in operation. According to another variant, the conduit 446 can be supplied with pressurized air from air used in the atomizer 2 for another function, e.g. from the skirt air circulating in the conduits 442.

The piston 106 also defines volumes V106 for receiving balls 108 which form members for engaging the piston 106 with the outer peripheral groove 646 of the sleeve 64.

Advantageously, a ball 108 is mounted in each volume V106.

Each ball 108 is accommodated in a volume V106 from which same may or may not protrude out through an opening O106 which forms the outlet of each volume V106 on the internal peripheral surface S106 of the piston 106.

Each volume V106 is defined, on the side opposite the opening O106 thereof, by a surface S106 converging forwards towards the longitudinal axis A100 and inclined with respect to the longitudinal axis by an angle α which is not zero, preferably comprised between 15° and 60°, else preferably between 30° and 50°.

The surfaces S106 of the different volumes V106 form cam surfaces for guiding the balls 108.

The magnetic-pneumatic system 100 further comprises a support 110 which is also annular in shape centered on the longitudinal axis A100 and which is formed by a solid body 110a and a profile 110b, both made of ferromagnetic material. The parts 110a and 110b of the support 110 are secured together by any appropriate means, in particular by bonding, crimping and/or welding.

In a variant, the support 110 is in one-piece.

The support 110 is equipped with pins 110c for indexing in position, about the longitudinal axis A100, with respect to the piston 106.

The support 100 is also equipped with stops 110d intended to engage in the volumes V106 from the rear of the piston 106, in order to hold the balls 108 in position in said volumes.

The support 100 carries an annular permanent magnet 112 which is arranged on the inner radial side of the support 100. In the example, the permanent magnet is secured to the profile 110b, e.g. by bonding.

On the other hand, the support 100, more particularly the body 110a thereof, defines a first frustoconical internal surface S110, centered on the longitudinal axis A100 and converging toward the piston 106, and a second frustoconical internal surface S′110, centered on the longitudinal axis A100 and diverging toward the piston 106.

The magnetic-pneumatic system 100 further comprises a flat spring 114 which forms an elastic member for returning the piston 106, and preferably the support 110, toward the front.

The flat spring 114 is formed by a steel blade. The use of a flat spring such as the spring shown in the figures has the advantage of permitting a relatively large axial stroke of the piston 106, while the axial bulk of the spring 114 is minimal.

In a variant, the flat spring 114 may be replaced by another elastic member, in particular an elastomer block or a spiral spring.

An assembly method for an atomizer 2 will now be explained.

In a first step, the subassembly 22 is formed by engaging the bowl 8 in the central opening O6 of the air supply skirt 6, until the magnet 14 and the surface 82 provide magnetic clamping between the elements 6 and 8. The step can be carried out in a workshop, in an environment conducive to precise work.

Then, in a second step, the subassembly 22 is mounted, i.e. directly mounted in one operation, on the main body 4, as explained hereinbelow. Said step can take place at the site where the atomizer 2 is used, e.g. a paint booth.

This assembly is done by an axial translational movement of the subassembly 22 parallel to the longitudinal axis A2. The axial translational movement is represented by the arrow T in FIGS. 1 and 3 to 6. No other movement of the air supply skirt 6, and hence of the subassembly 22, is needed to mount same on the main body 4.

Thereby, the mounting of the subassembly 22 on the main body 4 results exclusively from a relative movement of translation between said elements of the atomizer 2.

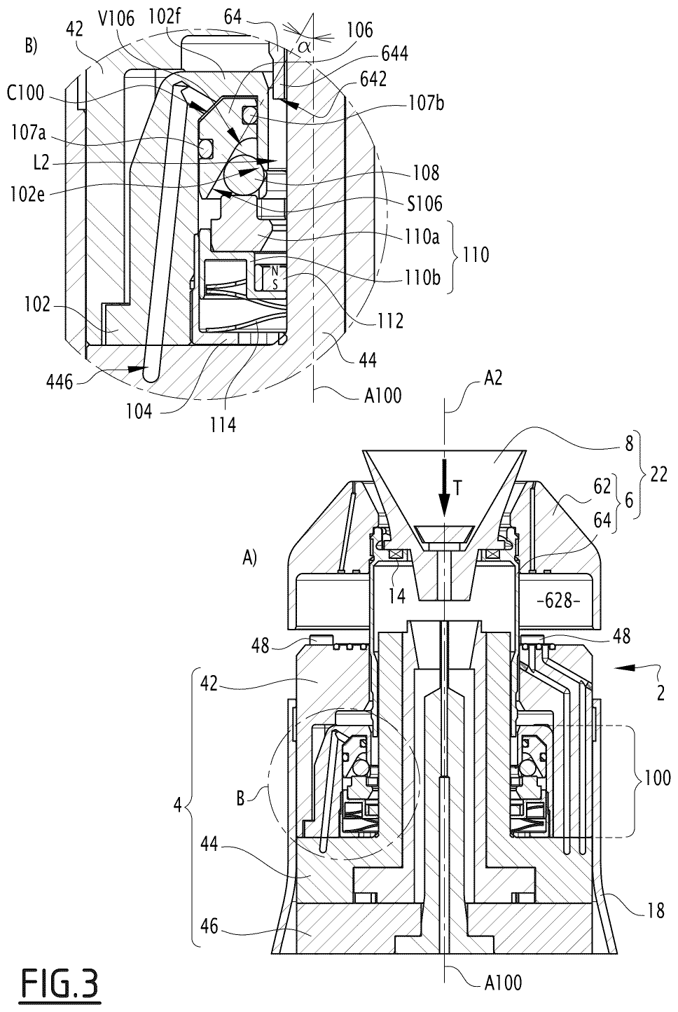

In a first sub-step of the second step shown in FIG. 3, the subassembly 22 is aligned on the axis A2 and brought closer to the main body 4. In said step, the rear end 644 of the sleeve 64 is engaged in the central housing L2, without being in contact with the components of the magnetic-pneumatic system 100.

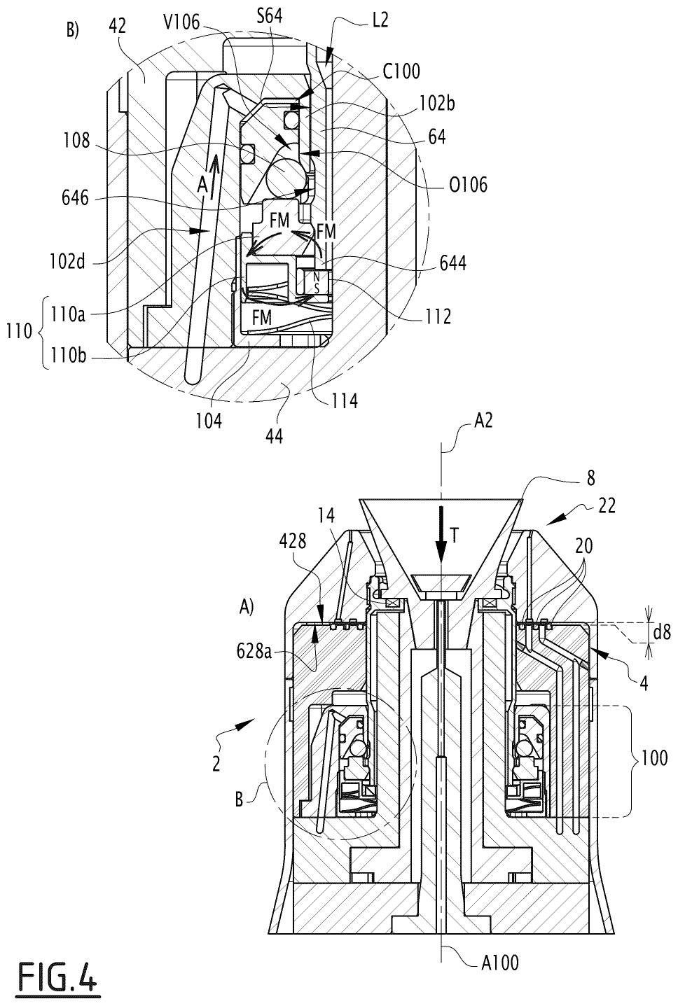

Continuing the mounting of the subassembly 22 on the main body 4 brings the sleeve 64 to the sub-step shown in FIG. 4, where the rear end 644 thereof bears by the edge 642 thereof against the permanent magnet 112, while the edge 647a bears against the surface S′110, which prevents a plastic deformation of the end 644 at the end of the stroke.

In said sub-step, a closed magnetic flux FM is established through the rear end 644 of the sleeve 64, through the parts 110a and 110b of the support 110 and through the magnet 112, which has the effect of joining, by an axial magnetic force of attraction, the air supply skirt 6 with the support 110, which is retained in position in the central housing L2 since same is limited in the movements thereof between the cap 102 and the cup 104. Thereby, the entire subassembly 22 is secured to the support 110. The axial magnetic force of attraction between the parts 12 and 64 is parallel to the longitudinal axis A2, preferably centered on the axis, and results in the hooking of the air supply skirt 6, and therefore of the subassembly 22, to the main body. Such force is thus a force to hook the parts together.

The permanent magnet 112 is chosen to exert on the sleeve 64 a magnetic hooking force of sufficient strength to retain in position the subassembly 22 on the main body 4, including when the latter is moved, e.g. when same is mounted on the wrist of the arm of a multi-axis robot or on a reciprocator, which subjects the subassembly 22 to the accelerations potentially oriented in a direction of extraction of the sleeve 64 with respect to the central housing L2.

In practice, the magnetic hooking force exerted by the permanent magnet on the sleeve has a strength I1 comprised between 10 and 20 daN, preferably on the order of 15 daN, which permits an effective hooking of the air supply skirt 6, and thus of the subassembly 22, onto the main body 4. On the other hand, the relatively moderate value of the strength I1 of the magnetic hooking force limits the risks of injury by pinching an operator when the he/she presents the subassembly 22 and engages the sleeve 64 in the central housing L2.

In the sub-step shown in FIG. 4, the subassembly 22 is hooked onto the main body 4 by means of the magnetic force, but the bottom 628a of the recessed housing 628 remains spaced away from the front face 428 of the external part 42 by an axial distance D8 which is not zero, the distance D8 being measured parallel to the longitudinal axis A2. In particular, in said sub-step, the seals 20 are not compressed and the sealing between the air circuits formed by the conduits 422 and 622 and the grooves 628c and 628d is not ensured with respect to the outside.

In the steps and sub-steps shown in FIGS. 1, 3 and 4, the spring 114 exerts on the support 110, a force of moving away from the cup 104, which has the effect of engaging the stops 110d in the different volumes V106, to the point that the stops 110d bear on the balls 108 which bear as such on the cam surfaces S106 of the piston 106, which has the effect of pushing the latter back toward the bottom 102f of the volume V102. The variable volume chamber C100 then has a minimum volume visible in particular in the insert B) in FIG. 3.

In such position, each ball 108 bears against the chamfered edge 102e of the cap 102, so that same is retained in position in the corresponding volume V106 without protruding radially from the wall 102b, along a direction radial to the longitudinal axis A100, and centripetal. Under such conditions, the balls 108 do not oppose the sliding of the sleeve 64 in the central housing L2, in particular during the succession of the steps shown in FIGS. 1, 3 and 4. More particularly, in the sub-step shown in FIG. 4, the balls 108 are not engaged in the outer peripheral groove 646.

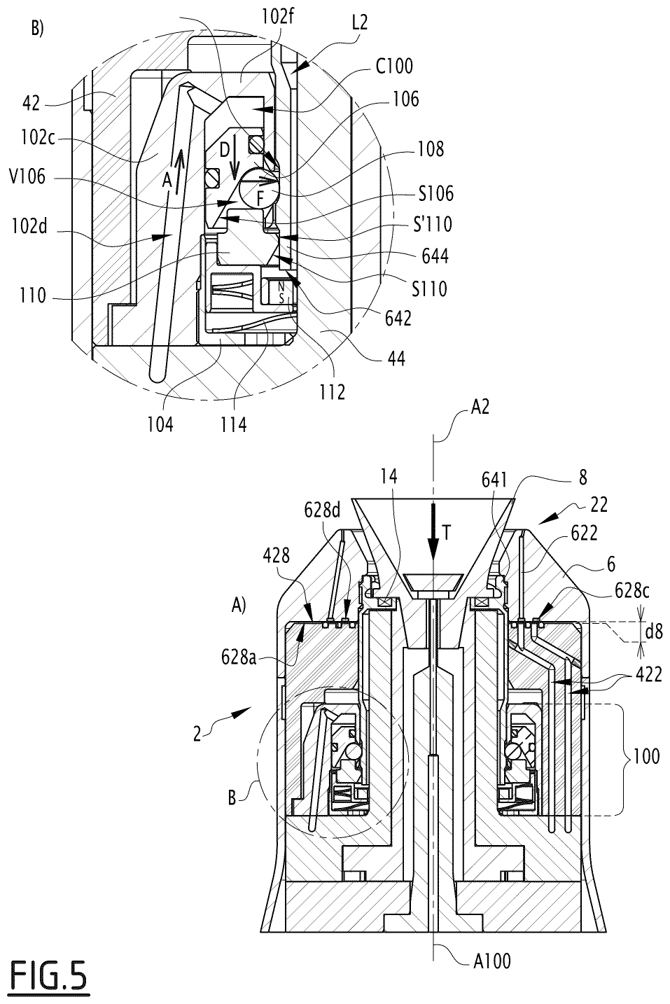

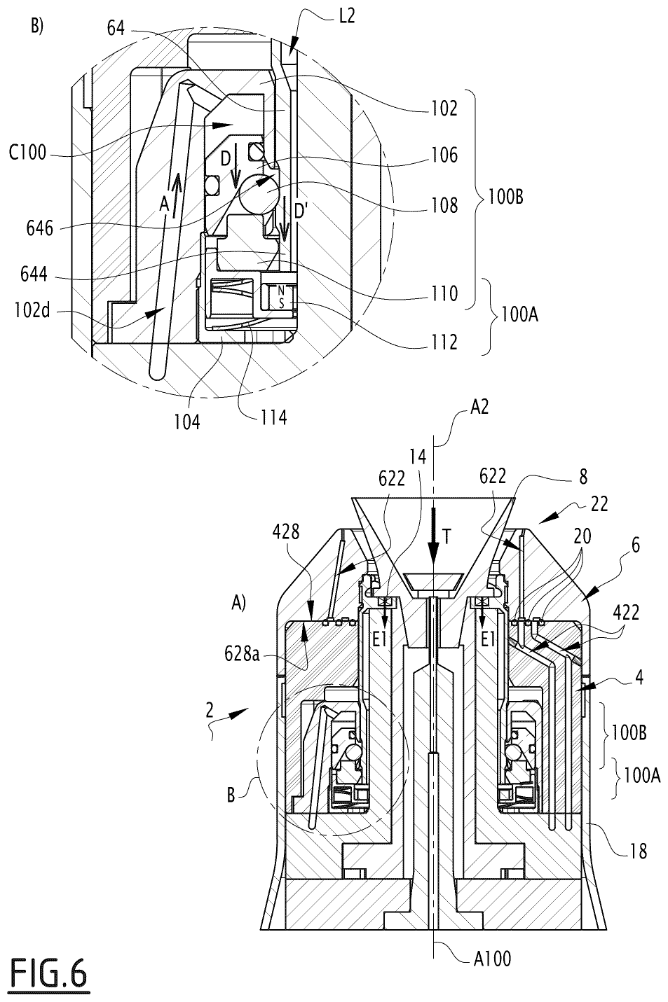

Starting from the sub-step of FIG. 4, the passage 102d is supplied with pressurized air, which is represented by arrow A in FIGS. 4 to 6. The above has the effect of pressurizing the variable volume chamber C100, which expands, i.e. dilates, toward the cup 104, as can be seen from the comparison of FIGS. 4 and 5. The axial expansion of the chamber C100 results from an axial movement, parallel to the longitudinal axis A2, of the piston 106 toward the cup 104, represented by the arrow D in FIGS. 5 and 6, the movement being due to the difference between the pressure inside the variable volume chamber C100 and the external atmospheric pressure.

The movement D of the piston 106 has the effect of moving the different balls 108 toward the cup 104, and hence the bottom of the central housing L2, the balls then becoming offset with respect to the chamfered edge 102e of the wall 102b, the edge then no longer going against the centripetal radial movement of the balls 108 through the openings O106. However, since the cam surfaces S106 of the different volumes V106 are oblique, the movement of the piston 106 toward the cup 104 has the effect of exerting on the different balls 108, a centripetal force with respect to the longitudinal axis A2, represented by arrow F in FIG. 5 and directed toward the outer peripheral groove 646. Thereby, the supply of air to the chamber C100 makes it possible to tighten different balls 108 around the sleeve 64, engaging same, i.e. making the balls penetrate, at least partially, into the outer peripheral groove 646. The balls 108 thus form members for engaging the piston 106 with the external relief of the sleeve 64 formed by the peripheral groove 646.

During the succession of the sub-steps shown in FIGS. 4 and 5, the balls 108 push the support 110 toward the cup 104, against the elastic force exerted by the spring 114, which has the effect of axially separating the spring 112 and the end 644 of the sleeve 64. In other words, in the sub-step shown in FIG. 5, the rear edge 642 of the sleeve 64 is no longer bearing against the magnet 112 and the edge 647a is no longer bearing against the surface S′110. The above is not a problem since the balls 108 engaged in the outer peripheral groove 646 then effectively retain the sleeve 64 in the central housing L2.

At the end of the sub-step of FIG. 5, the value of the distance D8 has decreased with respect to the value thereof in the sub-step shown in FIG. 4, but said value remains non-zero. The continued supply of pressurized air to the variable volume chamber C100 through the passage 102d causes the piston 106 to continue to move toward the cup 104, against the elastic force exerted by the spring 114, toward arrow D in FIG. 6. During said movement, the balls 108 abut against the rear edge 646a of the outer peripheral groove 646 and transmit to the sleeve 64 the movement force which the balls undergo due to the movement of the piston 106 toward arrow D. Thereby, the sleeve 64 is moved at the same time and over the same stroke as the piston 106, toward the bottom of the central housing L2, which is represented by the movement arrow D′ in FIG. 6.

The movement D′ of the sleeve 64 inside the central housing L2 has the effect of firmly pressing the bottom 628a of the recessed housing 628 against the front face 428 of the external part 42 of the body 4, compressing the seals 20, which fluidically isolates the conduits 422 and 622 and the grooves 628c and 628d from the outside. In other words, the pneumatic mechanism 100B exerts, on the sleeve 64 and by means of the balls 108, an axial mechanical clamping force parallel to the longitudinal axis A2, which firmly presses the bottom 628a of the recessed housing 328 of the air supply skirt 6 against the front face 428.

Thereby, the positioning and immobilization of the subassembly 22 on the main body 4 is carried out in two stages by means of the magnetic-pneumatic system 100. The pneumatic mechanism 100 B is thus also a mechanism for locking the subassembly 22 on the main body 4.

At the end of setting in place, the bowl 8, which is rigidly attached to the air supply skirt 6 due to the interaction of the first and second means of coupling 82 and 14, is pressed, by a magnetic force E1 parallel to the axis of rotation A2 and exerted by the means of coupling against the rotor 10, to the point that the friction forces between the surfaces 88 and 108 secure the bowl and the rotor in rotation about the axis of rotation A2.

Herein, the force E1 is purely axial with respect to the axis of rotation A2. In a variant of the invention (not shown), the force E1 is partially axial with respect to the axis of rotation, i.e. inclined with respect to the latter, as envisaged in WO 2005/082542A.

Since the bowl 8 is correctly positioned on the air supply skirt 6 due to the cooperation of the means of magnetic coupling 82 and 14, bringing the subassembly 22 into the position shown in FIG. 6 ensures that, in said position, the bowl is correctly positioned with respect to the rotor 10, in particular at the interface between the surfaces 88 and 108. The bowl 8 is then ready to be driven by the rotor 10.

When the turbine is operating, i.e. when the rotor 10 rotates about the axis of rotation A2, an air bearing is created between the surface 82 and the magnet 14 by injecting an air flow between the parts, according to the technique from WO2005/082542A1. The rotor 10 can thereby rotate the bowl 8 about the axis of rotation A2.

The mechanical hooking device 100A, which comprises the elements 110 and 112, serves to retain in position the subassembly 22 on the body 2 before the pneumatic clamping mechanism 100B, which comprises the elements 102, 106, 108 and 110, is used by supplying the variable volume chamber C100 with pressurized air to effectively clamp the air supply skirt 6, and hence the subassembly 22, in place on the main body 4, more particularly by compressing the seals 20. The cup 104 and the spring 114 are accessories of the mechanical hooking device 100A and of the pneumatic clamping mechanism 100B within the magnetic-pneumatic system 100.

The mechanical clamping force obtained by means of the pneumatic clamping mechanism 100B has a strength I2 strictly greater than the strength of the magnetic force mentioned hereinabove.

For example, the mechanical force obtained with the pneumatic tightening mechanism 100B may have a strength comprised between 80 and 200 daN, preferably between 100 and 150 daN, else preferably on the order of 120 daN.

When it is suitable to disassemble the subassembly 22 from the main body 4, the supply of pressurized air to the variable volume chamber C100 is stopped and the passage 102d is vented. The spring 114 then pushes the support 110, the balls 108 and the piston 106 toward the bottom 102f of the volume V102, reducing the volume of the variable volume chamber C100.

The balls 108 then abut against the chamfered edge 102e of the wall 102b, which has the effect of returning the balls toward the inside of the volumes V106, extracting same from the outer peripheral groove 646. In other words, the balls 108 are no longer engaged with the outer peripheral groove 646. Thereby, the elastic force exerted by the spring 114 tends to return the piston to a position wherein the balls 108 can be disengaged from the outer peripheral groove 646 of the sleeve 64.

By being pushed back by the spring 114, the support 110 drives with along the magnet 112 which comes into contact with the rear edge 642 of the sleeve 64, which has the effect of reactivating the magnetic hooking force between the sleeve 64 and the magnet 112. The magnetic-pneumatic system 100 is then in a configuration analogous to that of FIG. 4 where the seals 20 are no longer compressed and where the subassembly 22 remains hooked onto the main body 4 by the magnetic force resulting from the magnetic flux FM represented by the arrows F. The subassembly 22 is retained reliably on the main body 4 for the reasons explained hereinabove.

It is then possible to extract the subassembly 22 during a first disassembly step, by exerting an axial force in a direction opposite to the direction of arrow T in FIGS. 1 and 3 to 6.

In this respect, a disassembly tool (not shown) can be used for the above purpose.

Then, during a second disassembly step, the bowl 8 is separated from the air supply skirt 6, against the magnetic force between the magnet 14 and the surface 82. Like the first step of the assembly process, the second step of the disassembly method can be carried out in a workshop, in an environment conducive to precise work.

The structure of the subassembly 22 and of the magnetic-pneumatic system 100 of the invention is compatible with placing the subassembly 22 on the main body 4 by means of a robot, as well as with the removal thereof by means of a robot. Thereby, according to a particular aspect, the present invention makes it possible to automate the assembly and disassembly of an air supply skirt and of a bowl on and from the main body of a atomizer.

The variable volume chamber C100 of the magnetic-pneumatic system 100 can, in a variant, be supplied with a pressurized gas different from air.

According to a variant of the invention (not shown), the variable volume chamber C100 of the system 100 can be supplied with liquid, in particular water, to control the movement D of the piston 106. In such case, the system 100 is a magnetic-hydraulic system.

According to another variant, during the sub-step shown in FIG. 4, the edge 642 of the sleeve 64 abuts against the support 110 and not against the magnet 112. It is thereby possible to create a closed magnetic flux such as the closed magnetic flux FM shown in FIG. 4.

The magnetic-pneumatic system 100 can be used automatically, using the magnetic force generated by the permanent magnet 114 and controlling the supply of pressurized air into the variable volume chamber C100 or the chasing thereof by means of valves controlled by an electronic control unit (not shown). Thereby, the operation of the magnetic-pneumatic system 100 during the assembly or disassembly of the subassembly 22 can be automated, which relieves an operator working close to the atomizer 2 and makes his/her work less hazardous.

In a variant of the invention (not shown), the O-rings 20 are mounted in grooves formed in the bottom 628a of the recessed housing 628 and/or grooves equivalent to the grooves 628c and 628d are provided on the front face 428 of the outer part 42 of the main body 4.

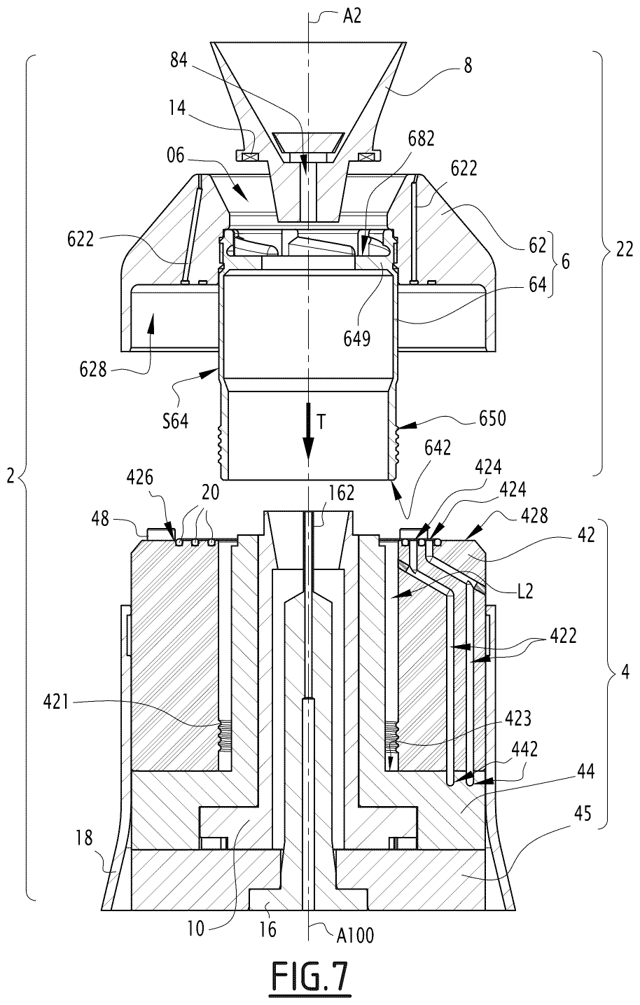

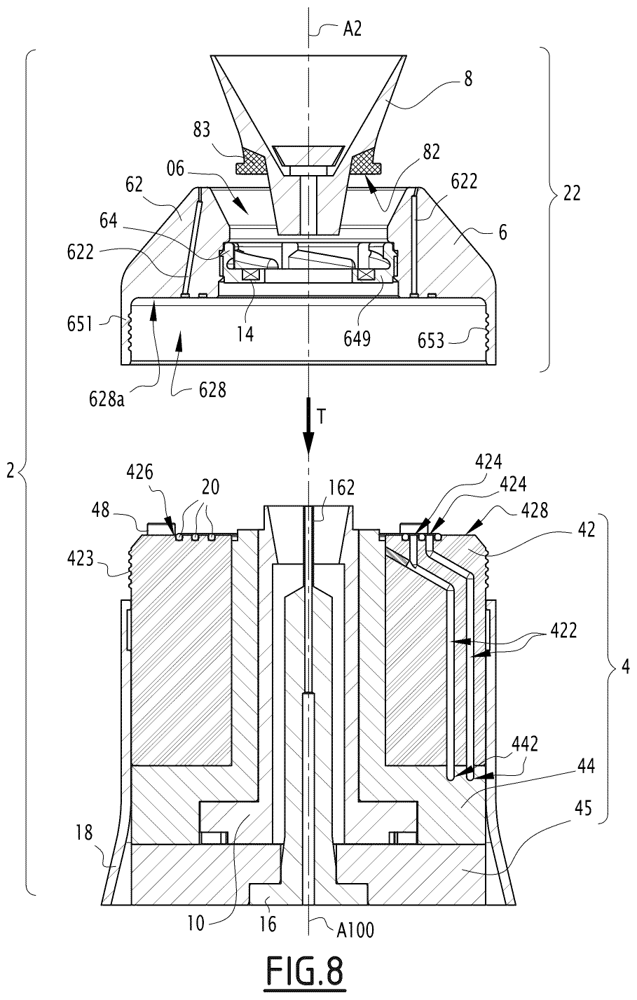

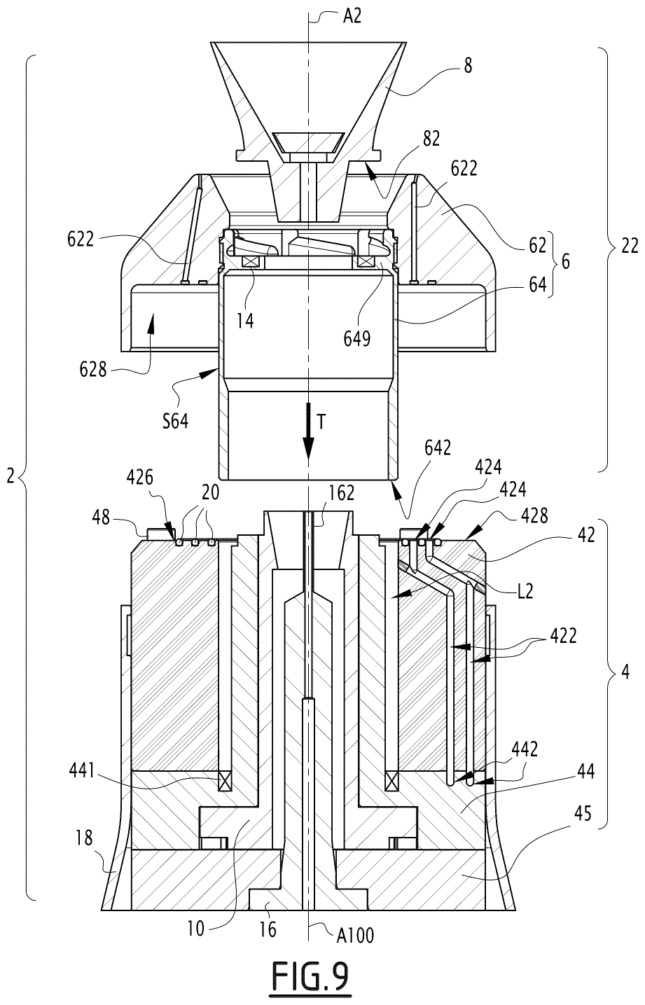

In the second, third and fourth embodiment of the invention shown FIGS. 7 to 9, elements similar to the elements of the first embodiment have the same references. Hereinafter, if a reference is used in the description without being shown in one of FIGS. 7 to 9 or is shown in one of said figures without being mentioned in the description, the reference refers to the same element as the element having the same reference in the first embodiment.

In the second, third and fourth embodiments, no magnetic-pneumatic or magnetic-hydraulic system of the type of the system 100 of the first embodiment, is provided.

In the second embodiment, the permanent magnet 14 is mounted on the bowl 8, while an annular front surface 682 of the collar flange 649, which is made of ferromagnetic material, is arranged opposite the magnet 14 in the mounted configuration of a subassembly 22 defined as in the first embodiment. The magnet 14 and the surface 682 of the collar flange 649 form first and second means of magnetic coupling between the parts 6 and 8.

The sleeve 64 of the air supply skirt 6 is provided, on the outer radial surface 64 thereof, with a thread 650, while the outer part 42 of the main body 4 is provided, in the housing L2, with a tapping 421 matching the thread 650. Thereby, once formed, the subassembly 22 can be screwed onto the main body 4 during the mounting of the air supply skirt 6 and of the bowl 8 on the atomizer 2, using the thread 650 and the tapping 421, until the rear edge of the sleeve is brought in abutment against the bottom 423 of the housing L2 or the bottom 628a of the recessed housing 628 in abutment against the front face 428.

On the other hand, during disassembly, the subassembly 22 is removed by unscrewing.

In the third embodiment, the permanent magnet 14 is positioned on the collar flange 649 as in the first embodiment. The surface 82 is formed by a ring 83 made of ferromagnetic material directly mounted onto the bowl 8 which is not necessarily made of ferromagnetic material and which is e.g. made of aluminum.

Herein, the sleeve 64 of the air supply skirt 6 mainly comprises the collar flange 649, but no part which extends into the recessed housing 628. A skirt 651 which surrounds the recessed housing 628 is provided, on the inner radial surface thereof, with a tapping 653, while the outer part 42 of the main body 4 is provided, on the outer radial surface, with a thread 423. Thereby, once formed, the subassembly 22 can be screwed onto the main body 4 during the mounting of the air supply skirt 6 and of the bowl 8 on the atomizer 2, using the thread 423 and the tapping 653, until the bottom 628a of the recessed housing 628 is in abutment against the front face 428.

On the other hand, during disassembly, the subassembly 22 is removed by unscrewing.

In the fourth embodiment, the surface 82 of the bowl 8 is in one-piece with the rest of the bowl and the permanent magnet 14 is positioned on the collar flange 649 as in the first embodiment.

Herein, a permanent magnet 441 is housed at the bottom of the housing L2 and cooperates with the rear edge 642 of the sleeve 64 to exert, on the subassembly 22 defined as in the first embodiment, a magnetic clamping force on the main body 4.

In a variant of the fourth embodiment, the magnet 441 can be mounted on the rear of the sleeve 64 and cooperates with the rotor which is then at least partly made of ferromagnetic material.

In the second, third and fourth embodiments, the atomizer 2 is assembled in two stages, as in the first embodiment. In a first assembly step, the air supply skirt 6 and the bowl 8 are assembled and held together by the magnetic force between the magnet 14 and the surface 82 or 682, so as to form the subassembly 22. In a second assembly step, the subassembly 22 is directly mounted in one operation onto the main body 4. During disassembly, in a first step, the subassembly 22 is separated from the main body in one operation. Then, in a second disassembly step, the air supply skirt 6 and the bowl 8 are separated from each other, against the magnetic force between the magnet 14 and the surface 82 or 682.

In a variant and whatever the embodiment, the atomizer 2 is an external charge electrostatic atomizer and comprises a high-voltage unit and charging electrodes (not shown) configured to bring the coating product atomized by the atomizer 2 to a given electrical potential.

According to another variant applicable to all embodiments, the atomizer is not an electrostatic atomizer.

In a variant, instead of a single annular permanent magnet 14, a plurality of permanent magnets distributed around the axis of rotation can be used as means of magnetic coupling.

In a variant, the surface 108 is not made directly on the rotor 10 but on another rotating member, e.g. a hollow shaft driven by the rotor.

The invention is described hereinabove within the framework of the use of the invention for spraying liquid coating products. The invention also applies to the spraying of powder coating product.

Insofar as is technically feasible, the embodiments and variants mentioned hereinabove can be combined.

1. A rotary atomizer for coating products comprising:
a main body; and
a bowl which is rotated by a rotating member about a rotation axis defined by the main body, the bowl being equipped with a first means of magnetic coupling apt to cooperate with a second matching means of magnetic coupling fastened to a non-rotating part of the rotary atomizer of coating products, the first and second means of magnetic coupling being apt to exert an at least partially axial force with respect to the axis of rotation of the bowl, the force inducing the coupling in rotation of the bowl with the rotating member, wherein the second means of magnetic coupling are supported by an air supply skirt directly mounted on the main body.

2. The atomizer according to claim 1, wherein the second means of magnetic coupling are mounted on, or formed by, an internal collar flange of the air supply skirt, bearing on a front face of the main body.

3. The atomizer according to claim 1, wherein the first means of magnetic coupling are formed by a ferromagnetic part of the bowl and the second means of magnetic coupling are formed by at least one permanent magnet.

4. The atomizer according to claim 1, wherein the first means of magnetic coupling are formed by at least one permanent magnet and the second means of magnetic coupling are formed by a ferromagnetic part of the air supply skirt.

5. The atomizer according to claim 1, wherein the atomizer comprises a magnetic-pneumatic or magneto-hydraulic system which includes:
a magnetic device for hooking the air supply skirt onto the main body; and
a pneumatic or hydraulic mechanism for locking and clamping the air supply skirt on the main body.

6. The atomizer for coating products according to claim 5, wherein:
the magnetic hooking device is configured to exert, between the air supply skirt and the main body, an axial magnetic force, parallel to a longitudinal axis of the atomizer, with a first strength; and
the pneumatic or hydraulic clamping mechanism is configured to exert between the air supply skirt and the main body an axial mechanical force, parallel to the longitudinal axis of the atomizer, with a second strength; and
the second strength is strictly greater than the first strength.

7. The atomizer for coating products according to claim 6, wherein the atomizer comprises seals arranged between the air supply skirt and the main body and wherein the seals compressed by the mechanical force exerted by the pneumatic or hydraulic clamping mechanism isolate conduits for the circulation of shaping air, provided in the main body and in a body of the air supply skirt, from the outside of the atomizer.

8. The atomizer for coating products according to claim 1, wherein the air supply skirt is provided with reliefs for screwing onto matching reliefs formed on the main body.

9. The atomizer for coating products according to claim 1, wherein the air supply skirt is clamped to the main body by a magnetic force exerted between a part of the main body and a part of the air supply skirt.

10. A method of assembling and/or disassembling the atomizer for coating products of claim 1, wherein, when assembling the atomizer:
in a first assembly step, the air supply skirt and the bowl are assembled and held together by a magnetic force between the first and second means of magnetic coupling; and
in a second assembly step, a subassembly formed by the air supply skirt and the bowl is directly mounted in one operation onto the main body; and
wherein, when disassembling the atomizer:
in a first disassembly step, the subassembly formed by the air supply skirt and the bowl is separated from the main body in one operation; and
in a second disassembly step, the air supply skirt and the bowl are separated from each other, against the magnetic force between the first and second means of magnetic coupling.
